(19) United States
(12) Patent Application Publication
(10) Pub. No.: US 2023/0311763 A1
(43) Pub. Date: Oct. 5, 2023

(54) Rear View Mirror Arrangement for a Motorcycle

(71) Applicant: Bayerische Motoren Werke Aktiengesellschaft, Muenchen (DE)

(72) Inventor: Andreas SCHLAYER, Muenchen (DE)

(21) Appl. No.: 18/022,409

(22) PCT Filed: Sep. 7, 2021
(86) PCT No.: PCT/EP2021/074546

§ 371 Date: Feb. 21, 2023

(30) Foreign Application Priority Data
Oct. 23, 2020 (DE) 10 2020 127 953.1

(51) Int. Cl. B60R 1/06; B62J 29/00; B60R 1/12; B62J 11/19

(52) U.S. Cl. CPC B60R 1/06; B62J 29/00; B60R 1/12; B62J 11/19

(57) ABSTRACT

A rear view mirror arrangement for a motorcycle, in particular for a motorbike or a scooter, is provided, having a mirror arm, which bears a mirror housing and/or a mirror element at an outer end, and having a fastening section, which is arranged at an end of the mirror arm in the vicinity of the vehicle, for fastening the mirror arm to the motorcycle. A cable harness runs in a cavity of the mirror arm between the outer end and an end of the mirror arm in the vicinity of the vehicle. The cable harness includes a coupling element for providing an electrically conductive connection to a cable provided on the vehicle, wherein the fastening section bears the coupling element.

### BACKGROUND AND SUMMARY

The invention relates to a rear view mirror arrangement for a motorcycle, in particular for a motorbike or a motor scooter, and to a motorcycle with a corresponding rear view mirror arrangement.

Rear view mirrors for motorcycles usually have a mirror arm which carries the rear view mirror and its mirror housing and is connected to the motorcycle by a vehicle-adjacent end. The attachment can be made, for example, in fixed fashion on the handlebars or in the region of the chassis.

Electrified rear view mirror arrangements are increasingly provided which have integrated electrical or electronic components such as mirror heaters, sensors, or optical display elements of driver assistance systems of the motorcycle. In order to supply current and/or signals to these components, these components are connected to the corresponding (control) equipment of the motorcycle via cable harnesses. The cable harnesses therefore usually extend from the mirror housing to far inside the vehicle structure of the motorcycle. In order to route the cable harnesses along the mirror arm as unobtrusively as possible into the mirror housing, the mirror arms have, for example, a tubular design and accordingly have a continuous cavity through which the cable harnesses extend.

In particular when being fitted, the mirror arm usually has to be rotated many times about its longitudinal axis in order to screw the mirror arm into a corresponding socket on the vehicle and fasten it in this way. However, the respective cable harness can here become twisted or subject to tensile stress, which risks damaging the cable harness.

Next, once the mirror arm has been successfully fastened, the cable harness must be continued inside the vehicle in order to establish contact there. Because of the usually very confined structural space, access is here often very limited and this makes it extremely difficult to fit the rear view mirror to the motorcycle.

An object of the invention is to advantageously develop a rear view mirror arrangement, in particular to simplify fitting.

This object is achieved with a rear view mirror arrangement and a motorcycle having such a rear view mirror arrangement in accordance with the independent claims. Advantageous embodiments can be found in the respective dependent patent claims.

Accordingly, a rear view mirror arrangement for a motorcycle, in particular for a motorbike or a motor scooter, includes:
a mirror arm which carries a mirror housing and/or a mirror element at an outer end, and
a fastening section which is arranged at a vehicle-adjacent end of the mirror arm in order to fasten the mirror arm to the motorcycle, and
a cable harness which runs in a cavity of the mirror arm between the outer end and a vehicle-adjacent end of the mirror arm,
wherein the cable harness has a coupling element for supplying an electrically conductive connection to a cable provided on the vehicle, wherein the fastening section carries the coupling element.

The rear view mirror arrangement is thus designed in such a way that the mirror arm is connected to the fastening section at its vehicle-adjacent end. The fastening section is provided for fastening the whole rear view mirror arrangement to the motorcycle. The connection of the vehicle-adjacent end to the fastening section can be, for example, integral, in particular using the same material, such that the two components (mirror arm and fastening section) are designed as a common part. Alternatively, the mirror arm can, however, also be connected to the fastening section, for example by a screwed or interlocking connection.

In the case of a screwed connection, the mirror arm can, for example, have at the vehicle-adjacent end a threaded section with an external thread which is screwed into a correspondingly formed socket of the fastening section with an internal thread. A lock nut can preferably be provided on the threaded section of the mirror arm for the purpose of additionally securing and rotationally positioning the mirror arm and the fastening section.

Of course, the arrangement can, however, also be provided the other way round. In this case, the fastening section can have the threaded section with an external thread which is or can be screwed into a correspondingly formed socket of the mirror arm with an internal thread. In this case too, a lock nut can preferably be provided on the threaded section of the fastening section as an additional securing means in order to prevent unintentional loosening.

In each case, the cable harness is designed to supply electric current and electric signals to the electrical and/or electronic components provided in the mirror element (such as, for example, a piece of mirror glass) and in the mirror housing, such as, for example, a mirror heater, sensors, lamps, and/or other optical display elements. For this purpose, the cable harness extends through the inside of the whole mirror arm. The mirror arm correspondingly has the cavity which extends from the outer end of the mirror arm to the vehicle-adjacent end of the mirror arm. For example, the mirror arm has a tubular design, wherein the cavity is formed by the interior, formed along its longitudinal extent, of the tube.

The cable harness arranged in the cavity can moreover be continued from the vehicle-adjacent end of the mirror arm to the fastening section and there have, at a first end of the cable harness, the coupling element which is provided for electrically conductive connection to the other cable which is to be provided on the vehicle, and is electrically conductively connected, for example, to a control device, a cable loom, or other electrical and/or electronic components of the motorcycle.

The coupling element is arranged on or in the fastening section and is connected to the fastening section with a force fit, with a form fit, and/or with a material bond. Put differently, the fastening section carries the coupling element, for example on an outer surface or in the inside of the fastening section.

This embodiment thus provides that the cable harness which exits the mirror arm at the vehicle-adjacent end ends in the region of the fastening section. The coupling element provided at this end is connected to the fastening section. The rear view mirror arrangement thus does not have a loose cable end which is an obstruction during fitting and would accordingly have to be taken into consideration.

In addition, an electrically conductive connection is produced only by coupling the coupling element to the cable on the vehicle. This can take place, for example, only once the rear view mirror arrangement has been successfully fitted, when it is already situated in the position provided. The risk of twisting or tensile stress caused by a rotational movement of the rear view mirror arrangement during fitting is thus completely avoided.

In addition, the cable on the vehicle can already have been laid inside the vehicle during the vehicle assembly such that access needs to be ensured, once the (remainder of the) motorcycle has been completed, only for the cable end to be coupled of the cable provided on the vehicle in order to establish contact with the cable harness but not for fitting of the rear view mirror arrangement.

The rear view mirror arrangement thus offers the possibility that it can be supplied completely pre-assembled and can be fastened to the motorcycle particularly simply as a complete unit. It is thus also easy for untrained people to attach the rear view mirror arrangement to the motorcycle.

For example, the coupling element can be designed as a male connector or as a female connector for supplying a plug-in connection. Accordingly, the cable on the vehicle can have a second coupling element designed as a mating piece which is thus designed as a female connector or male connector. The two coupling elements form, for example, an electrically conductive plug-in connection.

Furthermore, the fastening section can comprise a cable guidance element which carries the coupling element of the cable harness. The cable guidance element can here be designed as a single piece or single part with further parts of the fastening section or alternatively as a separate structural part. The cable guidance element is accordingly provided to guide the cable harness. In this way, it is, for example, possible to lay the cable harness precisely in the region of the fastening section.

The cable guidance element can thus be designed for strain relief of the cable harness and in particular a bend in the cable harness is provided for this purpose. The cable guidance element can form a corresponding cable duct for this purpose in which the cable harness is inserted and hence follows its course. This can be achieved, for example, by a groove-shaped course of the cable duct. Alternatively, the cable guidance element can form a wall which guides the cable harness on just one side. A further boundary can be supplied, for example, by another component of the fastening section.

For example, the cable guidance element can provide a bend in the cable harness by up to 180°. In a suitable arrangement, rotation of the mirror arm relative to the fastening section by this angular amount can thus be enabled without generating damaging tensile stress.

This provides the possibility that, in the event of an impact in a direction counter to the driving direction on the mirror housing or on the remote end of the mirror arm during operation of the vehicle, the mirror arm can be rotated accordingly without any risk of damage to the cable harness.

Furthermore, the fastening section can comprise an adapter element which supplies with a first side the described connection to the vehicle-adjacent end of the mirror arm and comprises a second end which is designed for connection to the socket section, on the vehicle, of the motorcycle.

The adapter element can moreover have a cavity which is open relative to the cavity of the mirror arm and connected thereto and moreover has an opening in a wall of the adapter element. The cable harness can extend from the mirror arm through the cavity of the adapter element as far as the opening of the adapter element and be routed through the opening onto an outer surface of the adapter element.

For example, the cable guidance element which has already been described can be designed in such a way that it guides the cable harness exiting the opening from the opening as far as the coupling element.

Furthermore, the fastening section can have a covering cap which covers the fastening section at least partially or completely, in particular on an upper side and/or lateral surface. The covering cap can be manufactured, for example, from elastic plastic or an elastic rubber material. This can be used with corresponding dimensioning to ensure that the covering cap seals the fastening section in order to protect the latter from moisture and dirt.

Furthermore, a motorcycle, in particular a motorbike or a motor scooter, is supplied, with a rear view mirror arrangement, wherein the rear view mirror arrangement is designed according to this description.

A motorcycle is to be understood as scooters, quad bikes, snowmobiles, jet skis, and the like in addition to the mentioned motorbikes and motor scooters.

The invention is explained in detail below with the aid of an exemplary embodiment with reference to the drawings.

### BRIEF DESCRIPTION OF THE DRAWINGS

FIG. 1 is an exploded view of a rear view mirror arrangement according to the description;

FIG. 2 is a perspective view of the rear view mirror arrangement;

FIG. 3 is a plan view of the rear view mirror arrangement according to FIG. 2;

FIG. 4 is a perspective view of the rear view mirror arrangement with no covering cap;

FIG. 5 is a plan view of the rear view mirror arrangement according to FIG. 4; and

FIG. 6 is a view in section A-A of FIG. 3.

### DETAILED DESCRIPTION OF THE DRAWINGS

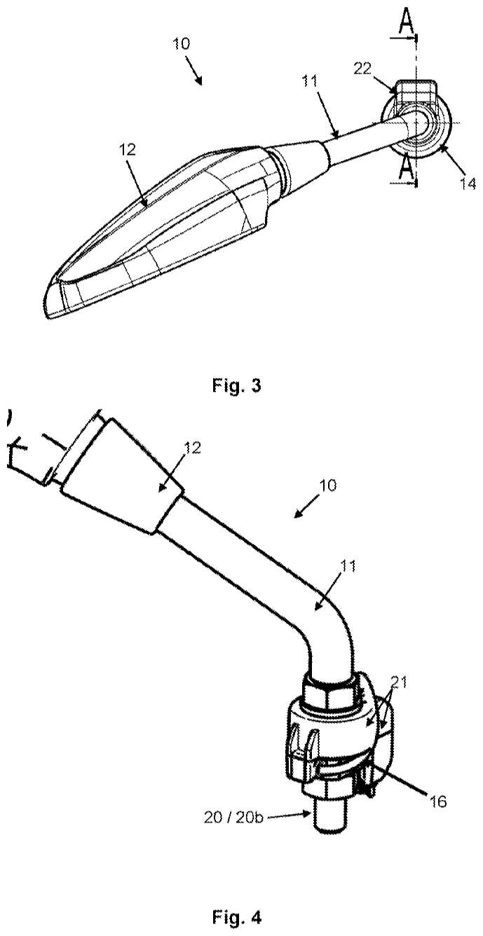

FIGS. 1 to 6 show an embodiment of a rear view mirror arrangement 10 for a motorcycle such as, for example, a motorbike or a motor scooter, according to this description. The rear view mirror arrangement 10 accordingly comprises, inter alia, a mirror arm 11 which carries at an outer end 11a a mirror housing 12 with a mirror element 13, such as a piece of mirror glass, arranged therein, and a fastening section 14 which is arranged at a vehicle-adjacent end 11b of the mirror arm 11 in order to fasten the mirror arm 11 and the whole rear view mirror arrangement 10 on the motorcycle. In the embodiment illustrated, the mirror arm 11 is connected to the fastening section 14 by a screwed connection. For this purpose, the mirror arm 11 has a threaded section 11c with an external thread which is screwed into a correspondingly formed socket 14a of the fastening section 14 with an internal thread. In the embodiment illustrated, the socket 14a is formed by an adapter element 20 described below in more detail. A lock nut 15 is provided on the threaded section 11c of the mirror arm 11 for additional securing and rotational positioning of the mirror arm 11 and the fastening section 14.

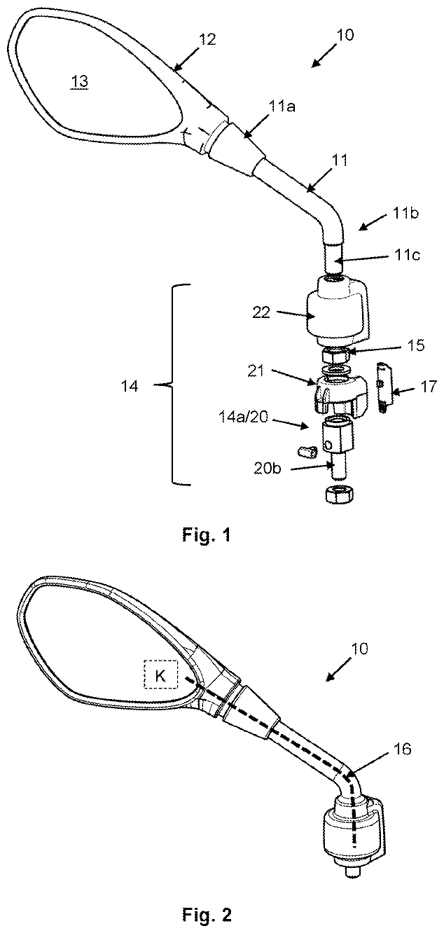

The rear view mirror arrangement 10 moreover comprises a cable harness 16 (the course of which is indicated by way of example in FIG. 2) which runs in a cavity 11d of the mirror arm 11 between the outer end 11a and the vehicle-adjacent end 11b of the mirror arm 11.

At a first end 16a of the cable harness 16, a coupling element 17 is provided which is designed for electrically conductive connection to a cable 18 provided on the vehicle (the free end of which is only indicated in FIG. 6), wherein the fastening section 14 carries the coupling element 17. This means that the coupling element 17 is fixedly connected to an outer surface of the fastening section 14. The rear view mirror arrangement 10 thus has no loose cable end which would have to be taken into account during fitting.

In each case, the cable harness 16 is designed to supply electric current and electric signals to the electrical and/or electronic components K provided in the mirror element 13 and in the mirror housing 12, such as, for example, a mirror heater, sensors, lamps, and/or other optical display elements. For this purpose, the cable harness 16 thus extends through an interior of the whole mirror arm 11. The mirror arm 11 accordingly has the cavity 11d which extends from the outer end 11a of the mirror arm 11 as far as the vehicle-adjacent end 11b of the mirror arm.

For this purpose, the mirror arm 11 has a tubular design, wherein the cavity 11d is formed by the interior, formed along its longitudinal extent, of the tube. The cable harness 16 is routed onward from the vehicle-adjacent end 11b of the mirror arm 11 to the fastening section 14 and there has, at its first end 16a, the coupling element 17. The cable harness 16 which exits the mirror arm 11 at the vehicle-adjacent end 11b thus ends in the region of the fastening section 14.

The coupling element 17 is designed by way of example as a female connector into which a second coupling element 19, designed as a male connector, of the cable 18 on the vehicle can be plugged in order jointly to supply an electrically conductive plug-in connection.

Alternatively, and therefore not illustrated, the coupling element 17 of the cable harness 16 can be designed as a male connector which can be connected to a second coupling element 19, designed as a female connector, of the cable 18 on the vehicle in order jointly to supply the electrical plug-in connection.

Furthermore, the fastening section 14 comprises the adapter element 20 already mentioned above which supplies with a first side 20a the connection of the fastening section 14 to the threaded section 11c of the mirror arm 11 and the vehicle-adjacent end 11b and comprises a second side 20b which is designed for connection to a socket section, on the vehicle, of the motorcycle. The second side 20b can, for example, also have a threaded section for screwing to the socket section on the vehicle. A (lower) lock nut can also be provided at this threaded section in order to align the whole rear view mirror arrangement 10 relative to the vehicle.

Moreover, the adapter element 20 has a cavity 20c which is open relative to the cavity 11d of the mirror arm 11, and moreover an opening 20d in a wall. The cable harness 16 extends from the mirror arm 11 through the cavity 20c as far as the opening 20d and moreover through the opening 20d onto an outer surface of the adapter element 20.

According to the embodiment illustrated, the fastening section 14 moreover comprises a cable guidance element 21 which carries the coupling element 17 of the cable harness 16 and is designed to guide the cable harness 16 exiting the opening 20d of the adapter element 20 from the opening 20d as far as the coupling element 17.

The cable guidance element 21 is thus designed for strain relief of the cable harness 16 and for this purpose supplies a bend in the cable harness 16.

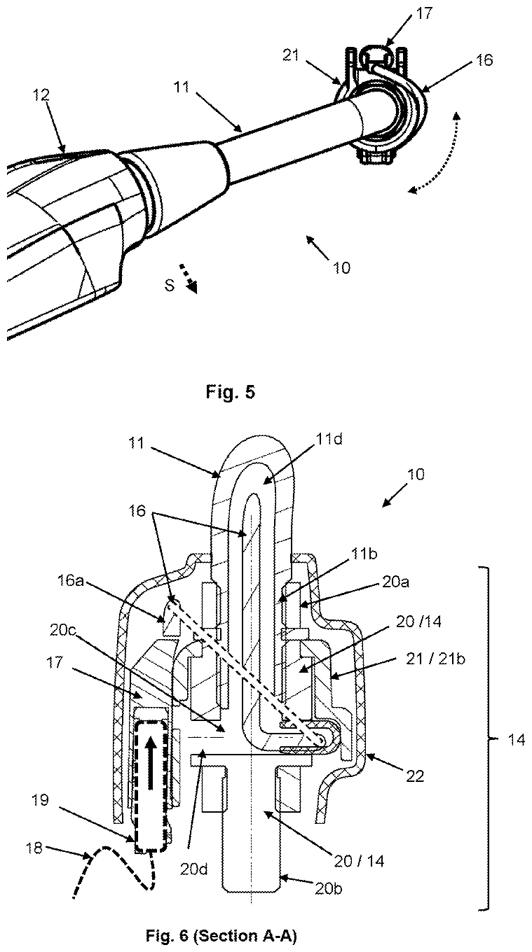

As can be seen in FIGS. 5 and 6, the cable harness is bent from one side of the cable guidance element 21 by 180° onto the opposite side, wherein the cable harness 16 is arranged on the side of the cable guidance element 21 which is remote from the vehicle.

This provides the possibility that, in the event of an impact S in a direction counter to the driving direction on the mirror housing or on the remote end 11a of the mirror arm 11 during operation of the vehicle, the mirror arm 11 can be rotated accordingly without any risk of damage to cable harness 16.

The cable guidance element 21 forms on its outer surface 21a a corresponding cable duct 21b for this purpose with a groove-shaped course in which at least part of the cable harness 16 is inserted and hence follows its course.

Furthermore, the fastening section 14 comprises a covering cap 22 which completely covers the fastening section 14 in the embodiment illustrated. For this purpose, the covering cap 22 encloses an upper side and a lateral surface of the fastening element 14. The covering cap 22 can be manufactured, for example, from elastic plastic or an elastic rubber material. This can be used with corresponding dimensioning to ensure that the covering cap 22 seals the fastening section 14 in order to protect the latter from moisture and dirt.

1.-9. (canceled)

10. A rear view mirror arrangement for a motorcycle, comprising:
a mirror arm which carries a mirror housing and/or a mirror element at an outer end;
a fastening section which is arranged at a vehicle-adjacent end of the mirror arm in order to fasten the mirror arm to the motorcycle; and
a cable harness which runs in a cavity of the mirror arm between the outer end and the vehicle-adjacent end of the mirror arm, wherein
the cable harness has a coupling element for supplying an electrically conductive connection to a cable provided on the motorcycle, and
the fastening section carries the coupling element.

11. The rear view mirror arrangement according to claim 10, wherein
the coupling element comprises a male connector or a female connector for supplying an electrically conductive plug-in connection.

12. The rear view mirror arrangement according to claim 11, wherein
the fastening section comprises a cable guidance element which carries the coupling element.

13. The rear view mirror arrangement according to claim 12, wherein
the cable guidance element is configured for strain relief of the cable harness.

14. The rear view mirror arrangement according to claim 10, wherein
the fastening section comprises an adapter element, the adapter element having a first end that provides the connection of the fastening section to the mirror arm, and having a second end which is configured for connection to a socket section on the motorcycle.

15. The rear view mirror arrangement according to claim 14, wherein
the adapter element has a cavity which is open relative to the cavity of the mirror arm, and has an opening in a wall of the adapter element,
the cable harness extends from the mirror arm through the cavity as far as the opening of the adapter element, and through the opening in the wall onto an outer surface of the adapter element.

16. The rear view mirror arrangement according to claim 10, wherein
the fastening section has a covering cap which covers the fastening section at least partially or completely on an upper side and/or a lateral surface.

17. A motorcycle comprising a rear view mirror arrangement according to claim 10.

18. The motorcycle as claimed in claim 17, further comprising:
the cable on the motorcycle, which cable is connected electrically conductively to the coupling element of the cable harness by way of a second coupling element.
